(19) United States
(12) Patent Application Publication
(10) Pub. No.: US 2007/0033059 A1
(43) Pub. Date: Feb. 8, 2007

(54) Multi-format, all media, creation method, event marketing software

(76) Inventor: Jennipher Adkins, (US)

Correspondence Address: Jennipher Adkins, PO Box 32121, Oakland, CA, 94604, US

(21) Appl. No.: 11/195,369

(22) Filed: Aug. 3, 2005

(51) Int. Cl. G06Q 99/00; G07G 1/14; G06Q 30/00

(52) U.S. Cl. 705/1; 705/14

(57) ABSTRACT

A media production method is presented in which multiple events are created and managed Events are created using the selection of templates and data bases. Each template can be transformed into multiple media formats. A user can populate a data base, where this data base will serve each media format requested by user. The embedded fields and the media content are not immediately joined until user initiates a preview of same. This method of fulfilling multiple media formats allows flexibility for the user to easily sample different formats with different template options without having to discard work because the data base represents the content. The pre-made template represents a depository for user's media and content and can be formatted into different media formats and styles. An advantage this method allows for a user to create a DVD, web site and an invitation without having to learn media authoring skills. Additionally, this method allows user to create uniform promotional items using a single program. This method also allows for more intimate commercial partnering between consumers and the business they choose to gift register with. This partnering method provides logo placement for the commercial entity and uniquely special treatment for event customers in the way of special items and time sensitive discounts based on specific items requested by customer. An administrative area is provided to store and manage all data bases and media content.

### FIELD OF INVENTION

The current invention has various objectives with regard to the simultaneous production of digital media, media creation, duplication, presentation, marketing and management.

### BACKGROUND OF THE INVENTION

Since the onset of digital gadgets, more people are utilizing technologically advanced tools in capturing, storing and utilizing media. One of the obstacles to capturing media is the ability to use it without having a high level of knowledge and skill in the art of editing and authoring media. Millions of people have been capturing photos and movie clips but are limited in the ways they are able to utilize their media. The most common utilization of media by the average customer is sharing photos usually via email attachments, printing images on paper or creating an “at home” video library.

### DESCRIPTION OF RELATED ART

The current forms of media utilization discussed above has drawbacks. Individuals are often overwhelmed by their digital media as it piles up because they are holding on to everything with the hopes they will eventually use it. However, this opportunity rarely happens because of the lack of personal skill in embarking on a media project beyond printing and emailing images.

The present invention overcomes this shortcoming. A patent search was conducted for software that offers the streamlined services as present invention does. No prior art was found.

### SUMMARY OF INVENTION

The present invention describes a process of simultaneously creating different media formats such as DVD's, CD's, paper items, apparel, and miscellaneous gadgets for any type of event as selected by a user with the ability for immediate dissemination of media format(s) to respective parties and recipients. Following a step-by-step process in present invention, a user can create an esthetically matching DVD, website, paper invitation, apparel and other miscellaneous items using one program. User can also offer customized items for sale by selecting a commercial partner, building a store, then adding items to the store. Currently, one must create each of these media formats separately. Thereby making it difficult to create professional multimedia projects in all formats affordably, efficiently with timeliness and ease. Doing so would require user to seek a DVD author, website developer, a hosting company, graphic artist and printer, etc. Moreover, having each format completed as a separate job would create an obstacle in attaining a “sameness” relative to look in the final product, because they would not be originating from the same event, template equipment or person.

One advantage of present invention will allow user the ability to select from an array of events to create media for. An event may include but not be limited to birthdays, anniversaries, weddings, business reports, auditions, etc. All events will have available templates. Users may also create a custom designed template. Thus, present invention can also be referred to as an event planner, that provides an array of multimedia options for promotion.

Another advantage of present invention gives the user the ability to simultaneously build multiple multimedia formats for an event by simply choosing those formats from a menu. A menu comprising of multiple media formats, will include but not limited to DVD, CD, Website, paper media, apparel and miscellaneous gadgets. Current invention will also comprise of pre-designed newsletters, reminder notices and greeting cards. This process will allow user to easily build one data base that will populate all templates of media formats selected by the user. For example, after following a single process within present invention, the user can select to build a website, DVD and a paper invitation for a wedding by populating a single data base that will be used in building the website, DVD and paper invitation. Multimedia formats comprise of embedded code that seeks content from relational data base.

Another advantage of present invention provides user the ability to begin the process of creating an event, and the ability to interrupt process, save, store and recall same with one program.

Another object of present invention is to provide an administrative area for the management and updating of multimedia formats and collateral for each event. Authorized user(s) can access existing files for existing events by typing in user name and password. User may elect to use default user name and password when a previous user name and password has been generated. Standard web based validation commonly used in the industry, will be utilized if user forgets user name and password.

User may also access other multimedia collateral from other sources and libraries which can also be saved in user's master data base. After the creation of an event, all collateral selected and used to build templates can be saved, stored or identified by a unique name. In addition to a master data base, present invention will also comprise of event sub data bases.

Yet another advantage of present invention will allow user to pre-design a rotation schedule using multimedia and collateral within database. Whereby user identifies if multimedia and collateral as a rotating production by directing image to appear at a certain location on a certain date. This allows user to build, send and process pre-designed media and collateral in advance for ongoing events and updates that can be received by a recipient and third party entity in the future (i.e. newsletters, monthly reports, web updates).

Yet another advantage of present invention is to offer a streamlined way to offer products or receive discounts, sponsorships and endorsements from third party commercial entities. This would partially be achieved by user accessing a web link and selecting products to sell or offers provided by commercial entities. User will be shown options on how to promote selected Commercial entity logos, discounts, sponsorships and endorsements on media to be disseminated. Commercial entity can also offer users and recipients re-occurring anniversary discounts every year for that special date in memory of the event.

Commercial entity products, discounts, sponsorships and endorsement implementation can comprise of products, scannable codes, discount codes and passwords to be used by recipients of collateral. Items for sale, offered by commercial entity, then selected by user can easily be placed in user's store. The user's store is activated with a few simple steps and will appear in the user's website. This will allow user a quick and easy way to direct invitees for a particular event and to all purchase a similar product that is offered on the user's web site, (i.e. a t-shirt for a family reunion). Commercial entity codes and passwords generated for an event will be stored in master data base and in event's data base for future reference. Discounts, sponsorships and endorsements will provide means for user to direct recipients to a targeted commercial entity relative to gift selection, service specialty, or fund raising. Commercial entities will receive long term advertising and financial benefits by user implementation due to logos placement onto DVD's, CD's, web sites, paper materials, apparel and other collateral purchased by user. Scannable codes and discount codes will direct traffic to commercial entities physical store(s) and website(s), whereby creating a brand new method of highly targeted marketing. Commercial entities will receive long term benefits of this type of marketing because their logos are permanent imprints on collateral of which users and recipients typically maintain as keepsakes and memorabilia and is often physically and mentally referenced (i.e. wedding, anniversary or graduation, etc.).

Another advantage of the administrative area of present invention allows user the ability to access and utilize past events that have been saved and stored (i.e. DVDs, CD's, web sites paper media and other collateral), thereby eliminating “electronic-file” clutter and the misplacement of hard copy items.

In Utilizing the present invention, the user needs only to remember an event type, such as a wedding, which would be more memorable than a file name. Present invention will archive events by event type and saved name. Multimedia formats and other collateral affiliated with event will also be filed under respective event for future accessibility.

Administrative area will also comprise of a search tool that can query by an event, a date, a name, location etc. Administrative area will also comprise of specialty event management tools, web tools and plug-ins that can be utilized to manage, update information. For example, backend area will comprise of management tools Plug-ins may include but not be limited to, calendars, wedding managers, newsletters, reminder notices, accounting software and greeting cards. Web tools will optimize web products ordered. Tools will be accessible and down-loadable from an online library wherein user may down load tools, updates and media while utilizing current invention.

Another advantage of current invention allows user the opportunity to purchase space on a remote hard drive, wherein providing user an option to securely store or backup their entire administrative area or just an individual event. Whenever information is accessed and changed, saved changes will be appear in user's local drive and in remote drive, using an internet connection. This remote drive will be especially needed if the user has minimal memory stored locally and or user wishes to store and access multiple events that comprise of multiple media formats that would drastically slow down local processor.

These and other advantages, features and objectives of the invention will be more fully understood from the following detailed description of the preferred embodiments which should be read in light of the accompanying drawings.

### BRIEF DESCRIPTION OF THE DRAWINGS

The accompanying drawings, which are incorporated in and form a part of the specification illustrate the embodiments of present the invention and, together with the description serve to explain the principles of the invention.

In the drawings:

FIG. 1A shows a diagram of hardware and backend work flow.

FIG. 1B illustrates a flow chart of front end user's overview.

FIG. 1C illustrates a flow chart on commercial partner selection procedures.

FIG. 1D illustrates a possible screen shot of “Choose Event and Template”

FIG. 1E illustrates a possible screen shot of “Select Media Formats”

FIG. 1F illustrates a possible screen shot of “Administration and Management Area”

FIG. 2 illustrates a flow chart of DVD checkout procedures.

FIG. 3 illustrates a flow chart of web services check out procedures.

FIG. 4 illustrates a flow chart of CD checkout procedures.

FIG. 5 illustrates a flow chart of print and customized media checkout procedures.

### DETAIL DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

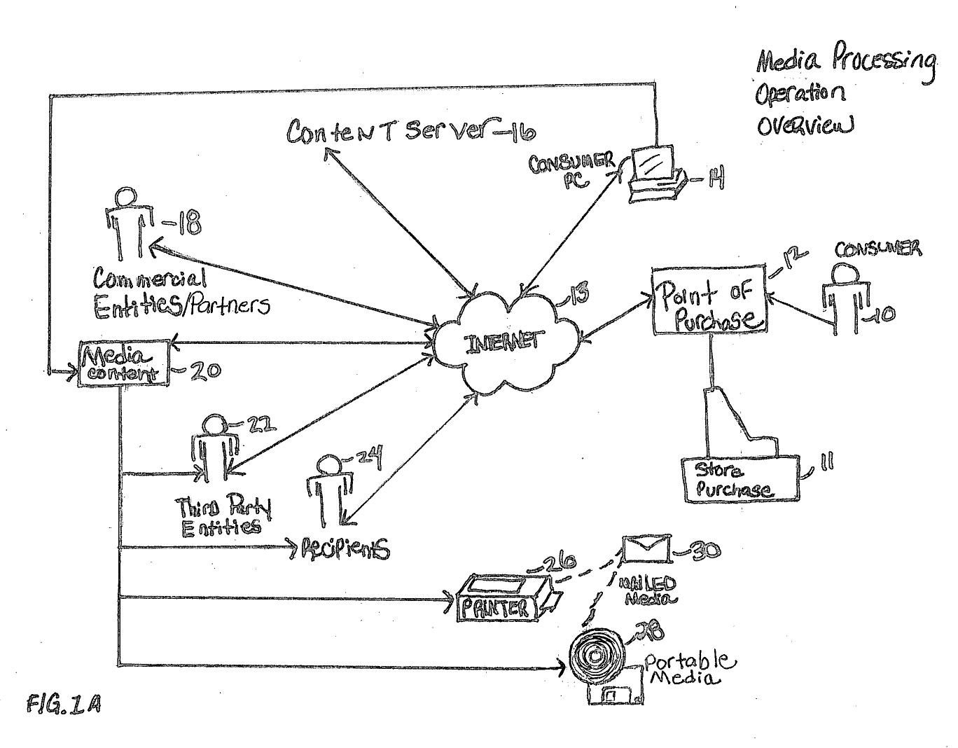

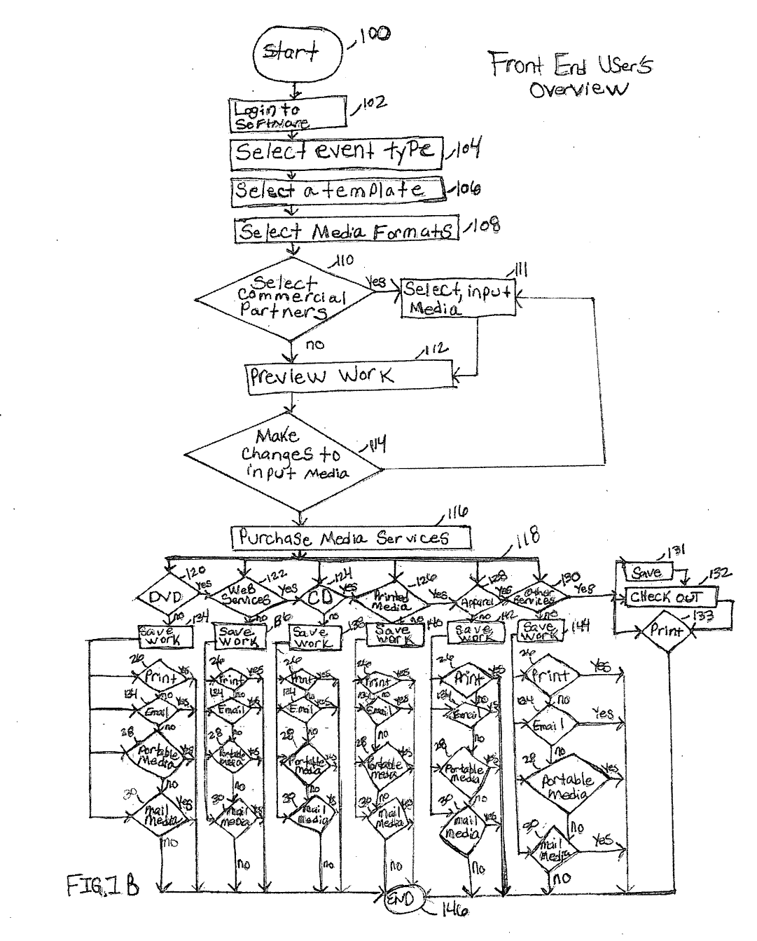

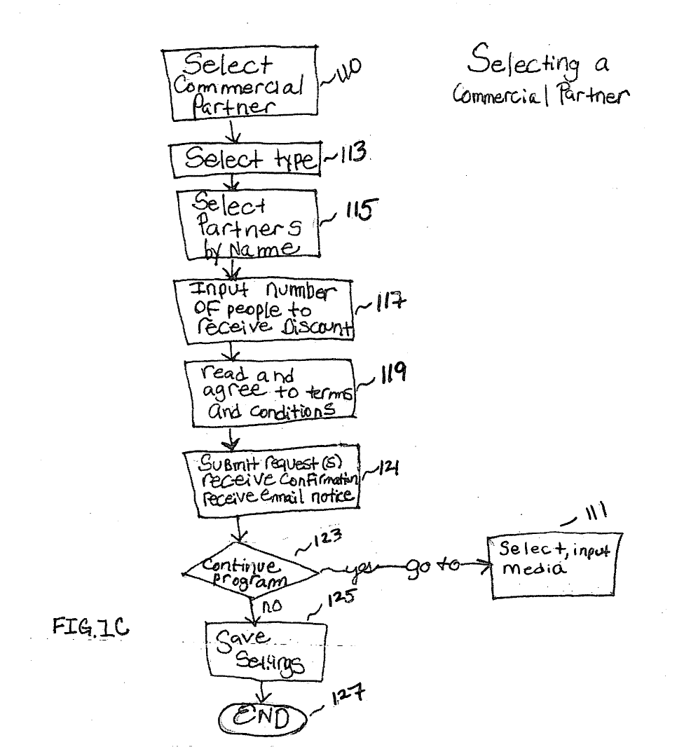

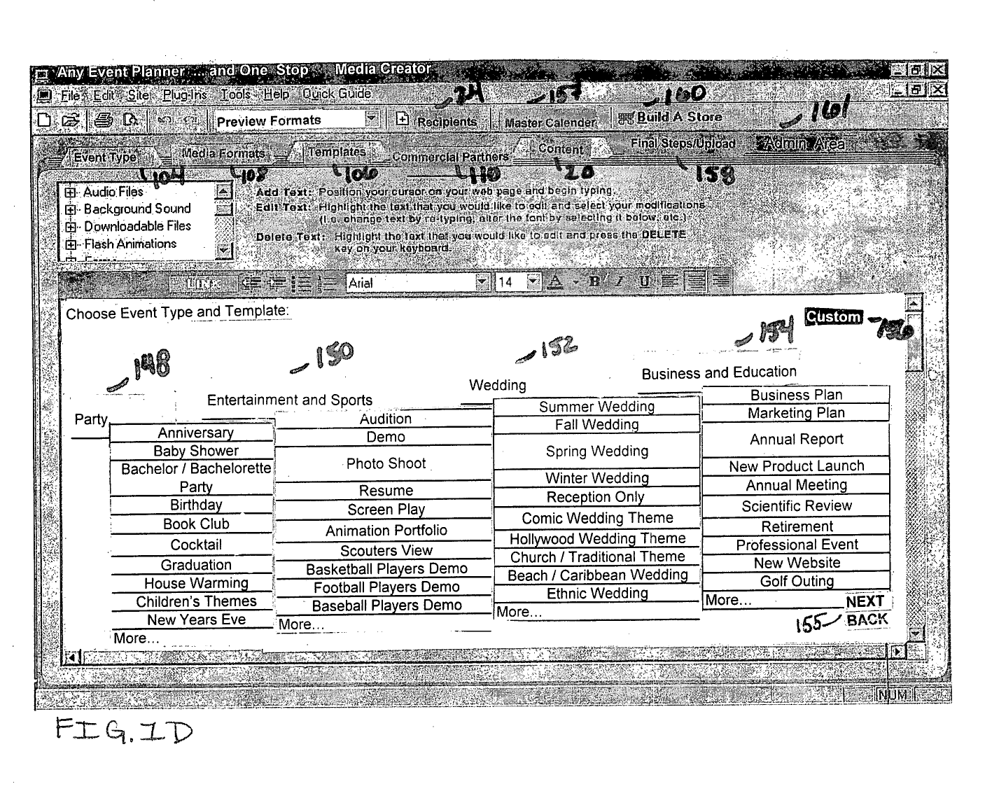

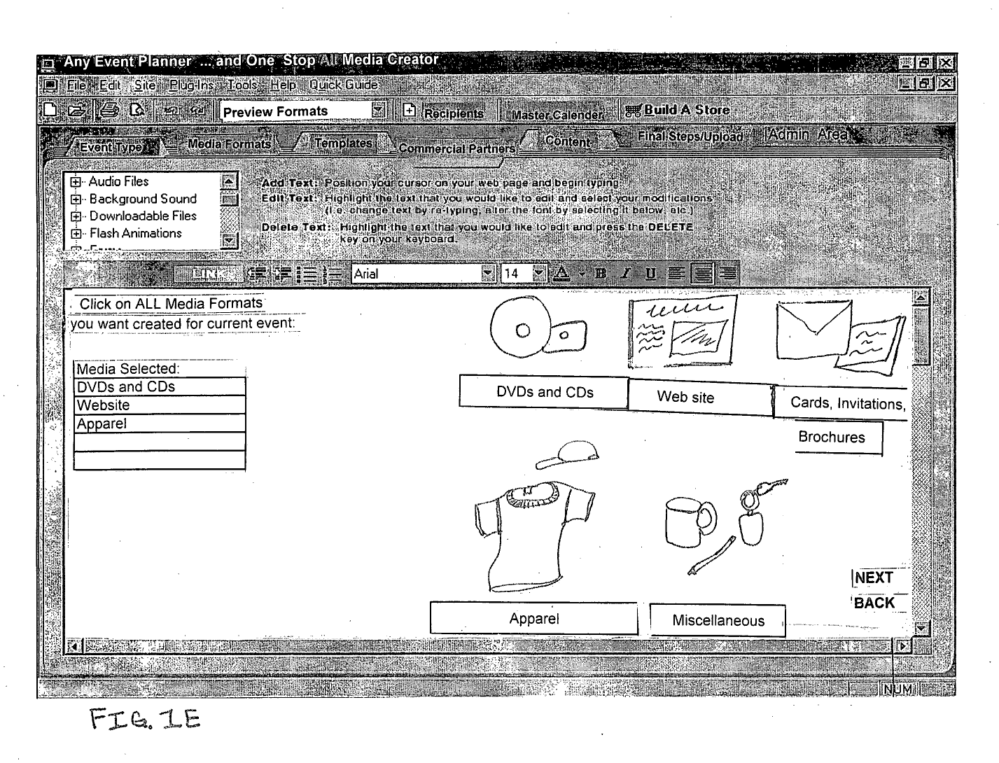

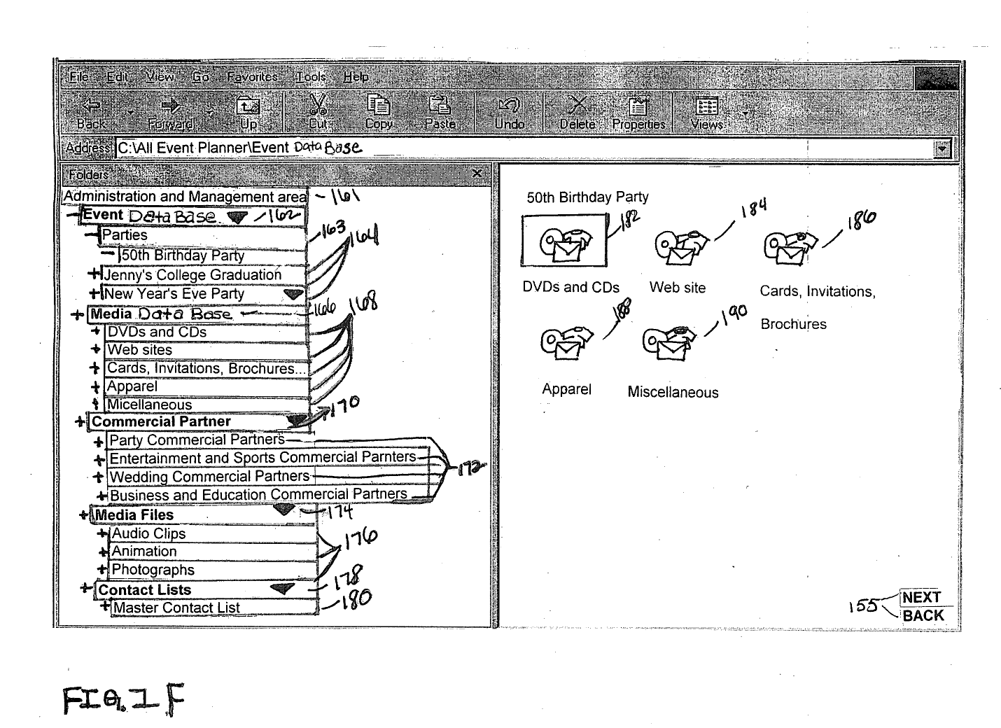

With reference to the drawings, in general, and FIGS. 1 through 5 in particular, the method and apparatus of the present invention is disclosed.

FIG. 1A. shows user, 10 relationship between commercial 18 and third party 22 entities, and recipients 24 while utilizing current invention. User acquires software by making a purchase electronically via the Internet or in person at a store. User can download or access software using a personal computer (PC)14 and an Internet connection 13. Once software is installed on PC, user may begin building media content 20 using their own media, media provided at point of purchase 12 or media provided from a web based library housed on content server 16, which is the online presence for current invention home.

Content server 16 comprises of a web based interface that allows visitors to complete the following but is not limited to, purchases (software, remote disk space, multimedia, templates), free down loads from a comprehensive multimedia library (i.e. video clips, photos, audio clips, songs, animation etc.) free downloads of templates, free and fee based downloads of specialized event tools (i.e. wedding planner, baby planner, vacation planner, special day reminder, business planner, etc.), downloads of software updates, and access to professionals seeking to work and assist users in accomplish objectives as set for in this invention.

User 10 will have the option to select various commercial entities 18 who offer products, discounts and other benefits to the user 10 and or recipients 24 of media content developed by user 10. Discounts and benefits can appear as scannable code or printed text that appears on media content 20. This option requires the user 10 to access a web based data base of pre-authorized commercial entities 18. In doing so, user 10 can choose which commercial entity 18 and which products, discounts and benefits offered by commercial entity 18 are most appropriate based on the particular event. User can choose to sell products offered by commercial entity by building a store. A customer (or recipient 24) shopping in user's store can complete a transaction on a commercial entity's backend server. User can build a store on content server 16 to eliminate having to purchase additional web services such as a merchant account or a secured socket layer (SSL). User would be allowed to utilize e-commerce area on content server 16 for their own custom products. User will also be able to securely establish remittance information for payments to be made to them (i.e. credit card, bank account or pay pal account) for rebates, profit sharing, or financial returns offered to user.

Media content 20 comprises of all media, multimedia, data bases, templates and any component thereof offered in present invention 12, 16, including content created for electronic means of transmission including but not limited to the emailing, uploading and disseminating of content to third party entities 22 and recipients 24. Media content includes but is not limited to a DVD, CD, website, apparel and printed material. Printed material templates include but are not limited to packaging options for DVDs, CDs, invitations, newsletters, and greeting cards. Media content 20 also refers to administrative area FIG. 1F content and other content that can be saved from users PC 14 onto portable media 28 formats such as a DVD, CD, zip disk etc. Media content also refers to media that can be sent to a printer 26. Media content saved onto portable media (i.e. DVDs, CDs, diskettes, printed paper items, apparel etc. 28 or sent to a printer 26 can also be mailed 30.

Third party entities 22 include but are not limited to service providers that provide various services as indicated by user while completing the checkout processes FIG. 1B, 2-5. Third party entities comprise of full service multimedia production companies, domain name registrars, web hosting companies, screen printing companies, promotion products companies, paper printing companies, mail processing companies, web design companies, photographers, videographers, travel agents, event planners, any entity user will rely upon in commission of accomplishing a goal while using present invention. Present invention provides user with media tools to effortlessly coordinate multiple digital and non-digitized media formats with a variety of third party entity service providers in a single occurrence.

Recipients 24 represent the user 10 and individuals on master contact list stored in data base, third party entities 22, commercial entities 18 and all individuals required the receive any portion of present invention in the commission accomplishing all objectives herein. Recipients can receive information via internet 13, mailed media 30and fax etc.

FIG. 1B shows a flowchart that depicts a broad overview of how users can interface with present invention. First user must access 100 and log into 102 software. Then user indicates what type 104 of event media is to be created. This will be partially achieved by selecting from a menu of event types FIG. 1D. Next, user selects a template 106. Templates 106 will offer a multitude of colors, themes, styles and can be customized. Each template design 106 is formatted in all possible media formats offered in present invention 108,118 (120-130). User can customize template relative to appearance and media format type in the event user selects more than one media format in which to exhibit event. This will automatically result in visually matching final products for all media created. User can delete, add or change a media format 118 for an event any time. Media can be purchased in one event or individually at check out 132. Media Formats that were-built for a particular event but whose services were not purchased may be purchased at a later time. This is partially achieved by user saving work then recalling same while in the administrative area FIG. 1F of present invention. Each event type 104 has an event data base (not shown) that prompts user for information and media. This database serves as the master content repository for all templates, media formats, and content used in building an event. For example, a “Birthday Party” template will exhibit different prompts, menu options and media suggestions compared to a “Wedding” template. Thus, the event type 104 selected by user also predetermines possible template options 106. By the time user arrives at the opportunity to select media formats 118, the present invention has established which embedded fields will exist within chosen templates 106. User can also change elements within template design for each media format. For example, if a DVD is to be created, user would have the option to select elements unique to a DVD such as “chapter” buttons. This step also requires user to select from a variety of packaging and presentation formats (for example, DVD's and CD's can be packaged in a single sleeve, a jewel and can be different sizes). Color and theme of packaging and presentation materials are also elements provided in the template options.

Next user is prompted to select, if any, commercial entities/partners 110, FIG. 1C. Via an internet connection, companies who wish to participate appear on a selection page. The objective of commercial entities 110 is to offer products, specials and discounts to recipients. In exchange, the commercial entity receives possible logo placement, online product sales, on going residual sales and-additional in-store spending by recipients who act on and utilize special offers and discounts. The list of potential commercial entities 110 would be endless, therefore users are given the option to narrow their search results by first selecting a “type” 113 of commercial entity. Once a commercial entity name 115 is chosen, user will then view all offerings for that entity. User is then given the opportunity to disclose the number of individuals or contacts to receive media content that promotes commercial partner. This information is gathered by commercial entity for quick and easy tracking, measuring and analyzing of metrics data and product availability for deals offered via this method. If user accepts the terms and conditions 119 offered by commercial entity, user then submits a request to partner with commercial entity, followed by receiving an immediate confirmation of this request via email. User is then given the opportunity to select 111, 114, view 112 and save various parameters relative to company logo and discount code generation and online product placement in users store, accessible from user's web site. User must determine logo and bar code placement, and logo size relative to where it would appear on final copy of media content 20.

It is advantageous to the user that commercial entity 110 selection occurs before and not after the process of populating event's master data base. Depending which commercial entity partnerships are created, products, discounts and specials can play a role in determining how user will develop media content 20. Company logo, and generated bar code and discount number is stored in event's master data base. Embedded fields in templates will point to or capture commercial entity's logo(s) and bar code(s) for designated placement.

User will now be prompted to input 111 data and media into event's master data base. As this process progresses forward, user is able to preview 112 work for each different media format 118 tselected. For example, user would be able exit a “development mode” 111 and enter into a “preview mode 112.” Preview mode 112 will allow user to select and view media formats that are under construction.-When user chooses to view a media format, its template will populate its embedded data fields using event's database. User will have the ability to view all pages or sections of any media format in preview mode 112. User must return to development mode to continue working or to make changes 114.

When user has completed the development of event data base, user can then purchase media services, 116 save, 131 check out 132 and print 133 work and exit program 146. User may also choose not complete online check out 132 but process and duplicate work from PC 14. User can email saved work 134-144 or media content 20 to recipients 24, print media from own printer 26, create portable media 28 that can be mailed 30 then exit 146 program.

Media services 120-130 relate to the serviceability of each media format offered in present invention. For example, to develop a DVD, website and a t-shirt for a “Birthday” event, saved as “Birthday 2005” user can complete the development 111 of the “Birthday 2005” data base 108 and can process different media formats on different days, using manual self service 26, 134, 28, 30 options or online services 120-130 offered by third party entity's 22. “Other services, 130” refers to any service needed to accomplish an objective of present invention not enumerated herewith.

FIG. 1D is a possible screen shot that illustrates how user can choose an event type and its respective template options while using present invention. An Event type list can comprise of a “Party,” 148 “Entertainment,” 150 “Wedding,” 152 and “Business and Education,” 154 template themes. User can also choose to create a template from scratch and not choose from templates provided in present invention 156. In doing so, present invention will store the custom template in the template data base and render multiple media formats for it as requested by the user.

The upper portion of this illustration also shows navigation buttons that provides user an interface to access a button to “Event Types,” 104 “Media Formats,” 108, FIG. 1E “Templates,” 106 “Commercial Partners,” 110 “[Media]Content,” 20 “Recipients,” 24 and “Master Calendar,” (not shown). Also shown is a “Final Steps/Upload,” 158 button, a “Build a Store,” 160 button and access to the “Admin. Area,” 161.

The Final Steps/Upload 158 area, will given user the opportunity to confirm send media, information and instructions to third party entities, and make payments for purchases.

The Build A Store 160 button provides access to an e-commerce set up area. This area allows user to establish products to be sold on web site. User may source products from commercial partners 110 or other sources. This option requires user to choose a website for launching.

Admin. Area 161 serves as backend management, maintenance and storage of features offered in present invention.

Referring now to FIG. 1E, this possible screen shot illustration comprises of an icon menu of media formats 108, 120-130 offered in present invention. As a user clicks on an icon, the present invention identifies its template on the backend and places that template format in event's data base. As user populates database for an event, each media format's template will seek “fulfillment” data for all empty fields embedded inside template. Using this method of media creation allows user to delete existing and select new templates and or media formats for an event without spending extra time starting over or jeopardizing existing work, while simultaneously producing different, personalized media products, because template content fulfillment originates from an event data base then disseminated “on demand” to templates.

Management of this data source is partially achieved by retaining the users work in index files in that particular event's-data base. Each saved template listed in FIG.1F, 182-190 is populated with the user's media content 20.

The Next and Back buttons 155 allow user to navigate pages while using present invention.

FIG. 1F is a possible illustration of an administration and management 161 area, master data and event data bases for current invention. This area is the storage location of all variations of media, and will allow user to access past and present projects. Present invention, including this area can use industry standards relative to “expanding” and “collapsing” files and basic file and task navigation and organization processes and procedures. User may access a past or present project by selecting header “Event Data Base,” 162 “then by reviewing each event in a sub directory 163 then by it's saved name, 164. This particular illustration further shows that a user has selected a file 182 located in the sub-directory, “Parties,” 163. Each item in sub-directory can have files 182-190. User can also access work via “Media Data Base,” 166 by querying media formats as the criteria 168.

User can also access historical data relative to a “Commercial Partner,” index tab 170. By accessing this area, user may review past and present commercial partners, discounts, products and special offers utilized. User may also access financial information relative to website sales history, profits and re-occurring anniversary notices offered by a commercial partner 18.

All media, used and unused, in present invention, can be stored in the various Media Files 174 listed. A “Media Files,” index button comprise of different media types and elements 176, 111 used to populate templates. Media in this section is does not appear with other media, whereby user can edit this media to fit a project. Contact list 178 is an address book that comprises of all recipient's contact information used in the dissemination of media and information using present invention. The contact list comprises of a master contact list 180 and distinctive contact list for each event (i.e. event contact lists) (not shown).

The arrows indicated on index headers denote that there are additional items in the series that are not visible. Thus, the item list that currently appears comprises of additional items under the headers 162, 166, 170, 174 and 178.

Additionally, the plug-ins that are selected are stored, and archived in the Administrative and Management area 161 Plug-ins comprise of any additional software tool to aid in the development and management of event planning and file management software offered in current invention. (i.e. additional wedding planning tools).

The icons shown in 182-190 represent software identification for current invention, which indicates that files identified with this icon are documents constructed and or saved using current program.

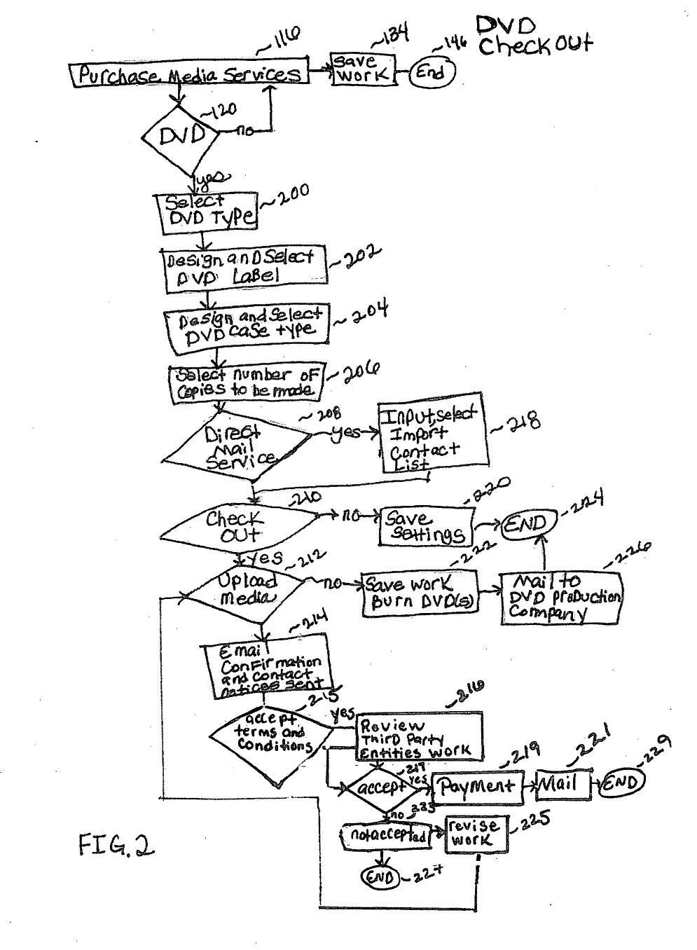

FIG. 2 indicates one interpretation of how front user can utilized current invention during DVD check out. This is partially accomplished by accessing media services area 116, 120-130. Media services area allows user to further customize accessories and other auxiliary elements that complete pre-selected media formats. For example, if user elects to develop a DVD for an event, it is in the media services phase where user would further customize the template, upload media to third party service provider, select size and shape of DVD 200, review and make changes to DVD label 202, select and or design DVD container type 204 and select number of copies 206 to be burned if uploaded to a third party. User also has the opportunity to instruct third party entity relative to how to disseminate approved version 208. Present invention allows user to import and export a contact list of recipients 218, that can be export to and utilized by third party entity.

By now the user has completed all necessary construction of media content 20 and can complete check out 210 or exit program 224 after saving work 220. The user can disseminate the media content 20 in various ways. User may opt to upload 212 content to a third party entity by accessing the internet and an upload tool. As an upload alternative, user may save work onto a DVD 222 using a local drive, then mail 226 DVD to recipient (s), including a third party entity. If user selects to complete online upload, an auto-response email confirmation is generated by entity 214 as proof of their receipt of user's media. Terms and Conditions 214 can also appear in auto-response. By replying to terms and conditions 215, user will also be given an opportunity to review a processed and or draft of media content form third party entity 216 user can select notice types, accept revised draft from third party entity 216 select notice types, accept draft 217, confirm costs 219 and have approved work mailed out 221. If first draft is not accepted 223 user can revise work 225, then upload 212 again to third party entity. User and third party entity can also discuss project and make revisions via other means, such as telephone conversations or email messages, etc.

In addition to providing convenience to the user, uploading media to a third party entity will provide additional electronic services without additional cost to either party. For example, under the authorization of the user, third party entities can generate and broadcast email notices to user's contacts/recipients, such as a “Coming Soon” interactive page, an “Address Confirmation Request” or an “Opinion Survey” 214 prior to sending out users approve work.

Third party entity will convert DVD template submitted by user into a working DVD format (i.e. MP3, etc.). Third party entity will also create an electronic authorization file comprising of this DVD that can be accessed via an emailed link to user. User may approve or make revisions. Final payment can be made upon accepted work. Final copy(s) are then mailed out and or download able from third party entity's server.

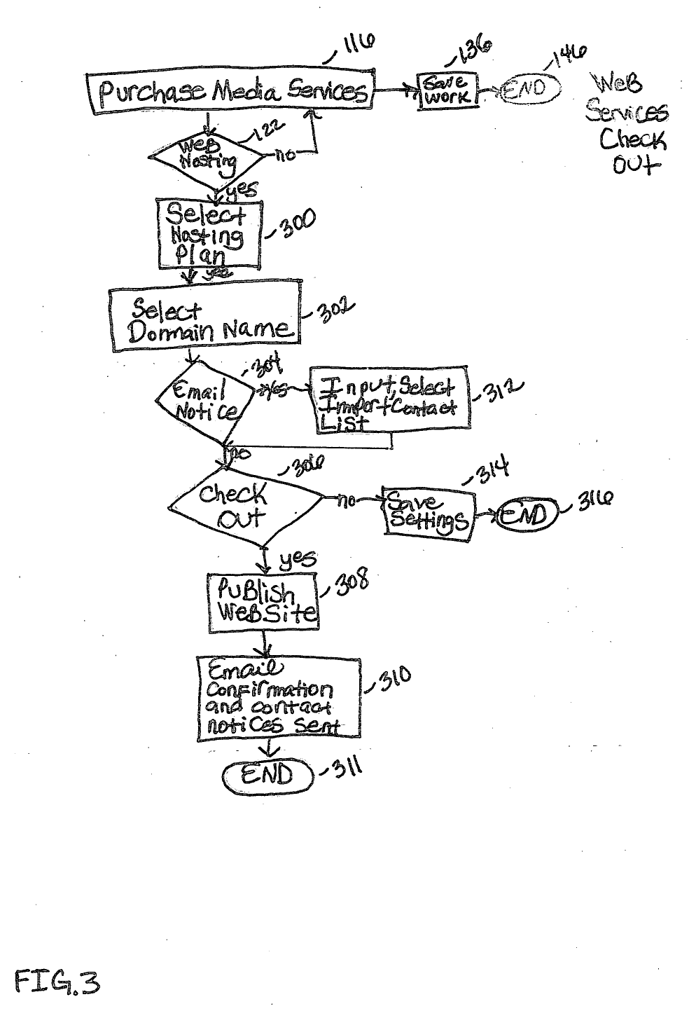

FIG. 3 refers to web services check out. User must complete web services/web hosting check out 122 process when the website media format and or the Build a Store option is selected. User can easily complete this process by selecting a hosting plan 300 and domain name 302. User then has option to send a broadcast email 304 to “launch” this newly created website when it is published and goes “live” on the world wide web. Email list is imported and or input 312 if user opts to send a launch email notice. User can continue check out process by paying for services 306 then publishing web site 308. User may opt not to immediately complete check out and save settings 314 and exit program 316. When website is published and live on the world wide web, the launch email broadcast is sent 310.

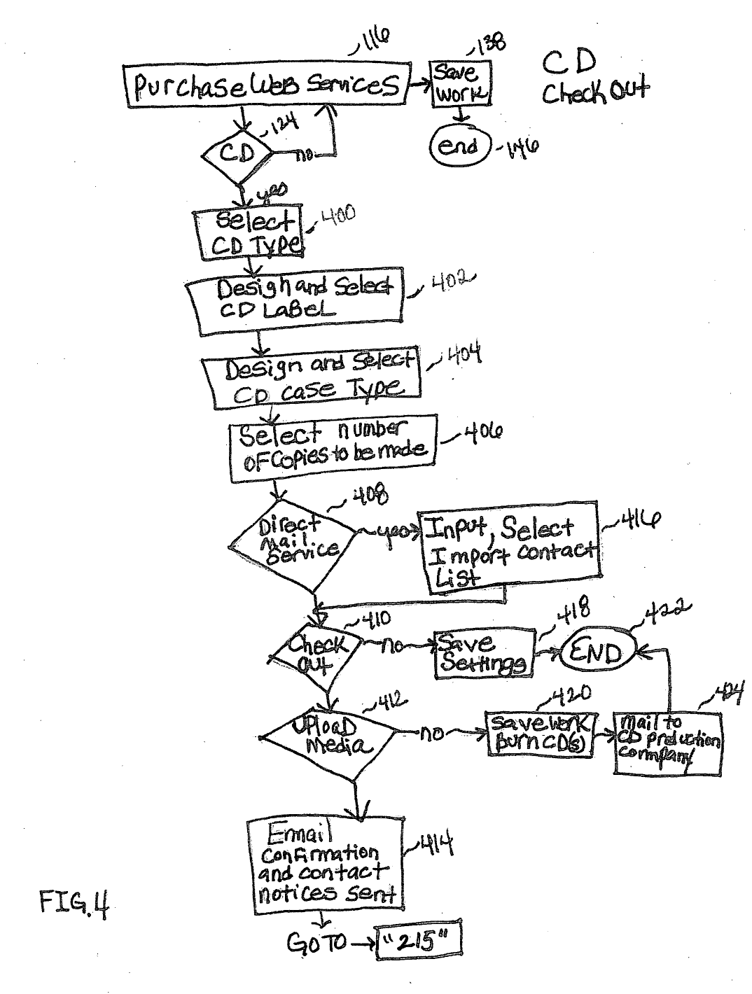

Referring now to FIG. 4, user is able to utilize current invention to produce and disseminate CDs. User must select CD type relative to capacity, technology size and shape 402. User then must select and design CD label 402 and case type 404. After indicating the quantity needed 406, user can then opt to have copies mailed directly 408 to recipients when work is approved by importing and or inputting contact list 416. User can continue online check out process by paying for services 410 then uploading media to third party entity 412. User may also opt not to complete on line check out process and save settings 418 and exit program 422. User may also opt to complete a “manual” checkout by saving work using local drive 420 then mailing CD to a production company 424 for mass duplication and other possible services. Uploaded media 412 will generate an auto response email confirmation sent to user/sender and notices to recipients 414, as instructed by user. User must then complete an accept and review process as enumerated in 215-217, 219 221, 223, 225, 227 229.

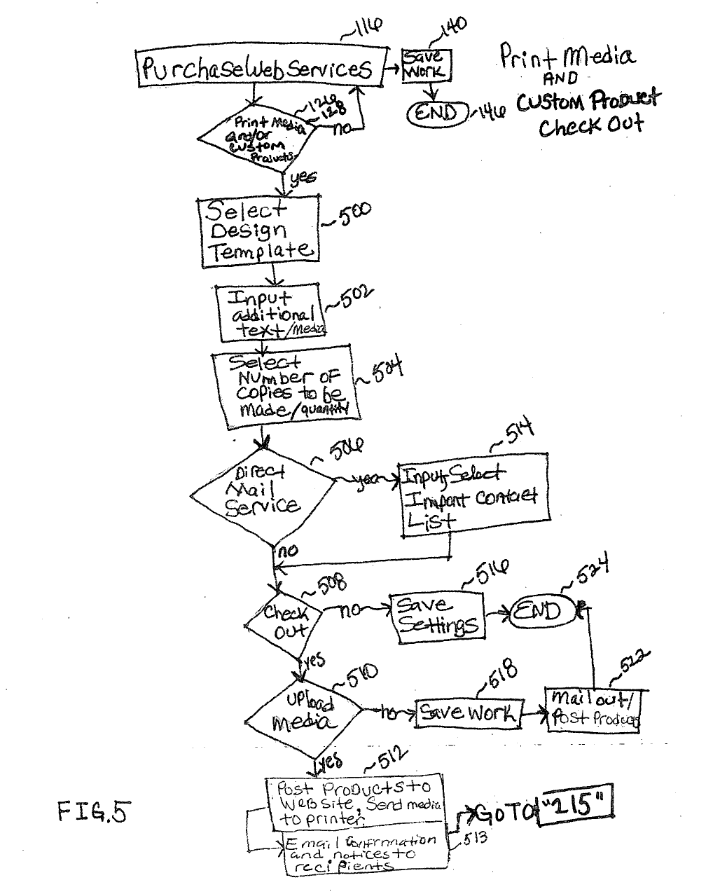

FIG. 5 is a flow chart that illustrates one way user may utilize current invention to create and reproduce custom printed media (i.e. greeting cards, brochures, reports, apparel products etc.) User may select a new design template 500 or use a template that may have been already selected in conjunction with other media formats. User is given an opportunity to introduce additional text and images to the format (s) being created 502. After indicating the quantity needed 504, user can instruct third party entity how to disseminate media. If user opts to use mail service 506, contact information must be provided 514. To complete on line check out 508, user must opt to upload media 510 to a third party entity or can save settings 516 and end program 524.

User may also opt to save 516 then reproduce and disseminate media 518 without contracting a third part entity. This is especially applicable relative to greeting card reproduction. Yet another option available to user is the ability to post custom produced products onto a web site 522. This is especially applicable to apparel and “miscellaneous” media formats. Uploaded media 510 may be received by a hosting company and or a printing company 512. Upload can generate an email confirmation and notices to recipients 513. User must then complete accept and review process as enumerated in 215-217, 219 221, 223, 225, 227 229.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed:

1. An online or off line computer implemented media generation and event management method that simultaneously generates one or more forms of media, for one or more events wherein a template is selected and a data base populated for the simultaneous population of one or more forms of media, and templates,
a method comprising:
selecting a template from menu;
selecting a format (s) to render a serviceable template(s);
selecting a commercial entity whereby a commercial entity may offer logos and other
identification markers for placement onto place holder that are stored in said formats; selecting discounts and any special offers as described or offered by commercial entity whereby user may place
computer generated scannable media or eye readable code onto embedded place holders; opting into a partnership with a commercial entity wherein user can enter in a marketing agreement with multiple companies, whereby, from a menu, a user can select a company, copy product images to be sold and incorporate discount codes to be utilized by media content created using present invention, whereby user and commercial entity can profit share of said products, whereby the user stores product images and discount codes in a data base, whereby this content can be electronically provided to a third party entity, a recipient, a printer, a portable media output.

2. The method in claim 1, wherein multiple services can be selected and processed whereby user can complete multiple payment transactions by, ordering services from multiple service providers in a single event.

3. The method in claim 2, wherein a final payment includes the unique parameters of all media formats ordered.

4. The method in claim 3, wherein each format has a separate pre-check out when more than one media format has been ordered by a user, whereby the user may also edit order.

5. The method in claim 4 wherein a master check out payment occurs, whereby a user can order and pay for all pre-checked out media.

6. The method in claim 5, wherein user creates, stores and purchases multiple forms of media for the promotion of multiple pre-defined or customized events using a single software program.

7. The method in claim 6, wherein a menu driven selection of formats is offered for simultaneous creation of said formats, whereby the user can select one or all formats to render media.

8. The method in claim 7, that disseminates completed templates of different formats to one or more respective third party entities for final production in a singe process, whereby a DVD/CD template is disseminated to a DVD and CD media company, a web hosting company receives web site template, a paper printing company receives camera ready art work, screen printer receives apparel printing instructions and other instructions are received by other respective third party entities use a single design and delivery system.

9. Method in claim 8, wherein a master template for each event and for each format is utilized, whereby a step process is designed to populated exact data fields on templates of all formats.

10. Method in claim 9, wherein a discount offered by a commercial entity can immediately be digitally realized and rendered at next check

11. Method in claim 10, wherein a code can be electronically generated for commercial entity and will appear on media content as designated by user.

12. Method in claim 11, wherein user is able to visualize a sampling of all media content comprising a template, whereby user is able to sample view how each media format renders using various templates.

13. Method in claim 12, wherein present invention allows for commercial entity registration on online, whereby a directory of individuals, professionals and companies seeking to offer services can complete and registration process.

14. Method in claim 13, wherein all products and services offered online are paid for in one event

15. A computer implemented system for managing generated, stored, indexed media, a system comprising:
means of creating a validation and user permission;
means of retrieving data relating to a saved past event and a current event;
means of storing content using event criteria.
means creating, storing and accessing a master calendar

16. The system in claim 15, wherein a master contact list is stored, accessed and updated

17. The system in claim 16, wherein an event contact list is stored, accessed and updated

18. The system in claim 17, wherein multiple databases are stored, accessed and updated

19. The system in claim 18, wherein files created or utilized in present invention are stored, accessed and updated

20. The system in claim 19, wherein a database of commercial entity discounts acquired by a user can be stored in a database and accessed by user when making purchases

21. A computer implemented method that retrieves detailed code, then generates multiple digital formats of same to render a predetermined formatted appearance with functional outcomes, whereby a user can create customized media that will allow present invention to convert said media into multiple media formats as set forth throughout this specification.
